(19) United States
(12) Patent Application Publication
(10) Pub. No.: US 2020/0364111 A1
(43) Pub. Date: Nov. 19, 2020

(54) FAILURE-BASED STORAGE REBUILDING

(71) Applicant: International Business Machines Corporation, Armonk, NY (US)

(72) Inventors: Ning Ding, Shanghai (CN); Zhen Nyu Yao, Shanghai (CN); Bo Zou, Urumqi (CN); Yao Dong Zhang, Shanghai (CN); Yan Lin Ren, Shanghai (CN); HongXin Hou, Shanghai (CN)

(21) Appl. No.: 16/415,808

(22) Filed: May 17, 2019

(51) Int. Cl. G06F 11/10; G06F 11/20; G06F 11/14

(52) U.S. Cl. CPC G06F 11/1092; G06F 11/1469; G06F 11/2094

(57) ABSTRACT

A computer-implemented method, a computer program product, and a computer system for failure-based storage rebuilding. One or more processors determine an inaccessible memory block of a source storage device. The one or more processors obtain address information of the inaccessible memory block of the source storage device. The one or more processors rebuild the inaccessible memory block of the source storage device, based on the address information. The one or more processors rebuild remaining memory blocks of the source storage device.

### BACKGROUND

The present invention relates generally to storage technology, and more particularly to failure-based storage rebuilding.

Generally, a storage system may include a plurality of storage devices. Such storage system may have a Redundant Array of Independent Disks (RAID) storage configuration to maintain the availability of the storage system. When a storage device in the storage system fails, the RAID storage configuration may be helpful to rebuild data associated with the failed storage device on a spare storage device in the storage system. After data is rebuilt on the spare storage device completely, the spare storage device takes the place of the failed storage device.

### SUMMARY

In one aspect, a computer-implemented method for failure-based storage rebuilding is provided. The computer-implemented method includes determining, by one or more processors, an inaccessible memory block of a source storage device. The computer-implemented method further includes obtaining, by the one or more processors, address information of the inaccessible memory block of the source storage device. The computer-implemented method further includes rebuilding, by the one or more processors, the inaccessible memory block of the source storage device, based on the address information. The computer-implemented method further includes rebuilding, by the one or more processors, remaining memory blocks of the source storage device.

In another aspect, a computer program product for failure-based storage rebuilding is provided. The computer program product comprises one or more computer-readable tangible storage devices and program instructions stored on at least one of the one or more computer-readable tangible storage devices. The program instructions are executable to: determine, by one or more processors, an inaccessible memory block of a source storage device; obtain, by the one or more processors, address information of the inaccessible memory block of the source storage device; rebuild, by the one or more processors, the inaccessible memory block of the source storage device, based on the address information; and rebuild, by the one or more processors, remaining memory blocks of the source storage device.

In yet another aspect, a computer system failure-based storage rebuilding is provided. The computer system comprises one or more processors, one or more computer readable tangible storage devices, and program instructions stored on at least one of the one or more computer readable tangible storage devices for execution by at least one of the one or more processors. The program instructions are executable to determine, by one or more processors, an inaccessible memory block of a source storage device. The program instructions are further executable to obtain, by the one or more processors, address information of the inaccessible memory block of the source storage device. The program instructions are further executable to rebuild, by the one or more processors, the inaccessible memory block of the source storage device, based on the address information. The program instructions are further executable to rebuild, by the one or more processors, remaining memory blocks of the source storage device.

### BRIEF DESCRIPTION OF THE SEVERAL VIEWS OF THE DRAWINGS

FIG. 1 depicts a cloud computing node, in accordance with one embodiment of the present invention.

FIG. 2 depicts a cloud computing environment, in accordance with one embodiment of the present invention.

FIG. 3 depicts abstraction model layers, in accordance with one embodiment of the present invention.

FIG. 4 depicts an exemplary schematic diagram of a storage system.

FIG. 5 depicts a schematic flowchart for failure-based storage rebuilding, in accordance with one embodiment of the present invention.

FIG. 6 depicts an exemplary schematic diagram of a storage system, in accordance with one embodiment of the present invention.

FIG. 7 depicts a schematic flowchart of a process of determining an inaccessible memory block of a source storage device, in accordance with one embodiment of the present invention.

FIG. 8 depicts a schematic flowchart of further steps of shown in FIG. 5, in accordance with one embodiment of the present invention.

FIG. 9 depicts a schematic flowchart of further steps of shown in FIG. 5, in accordance with another embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

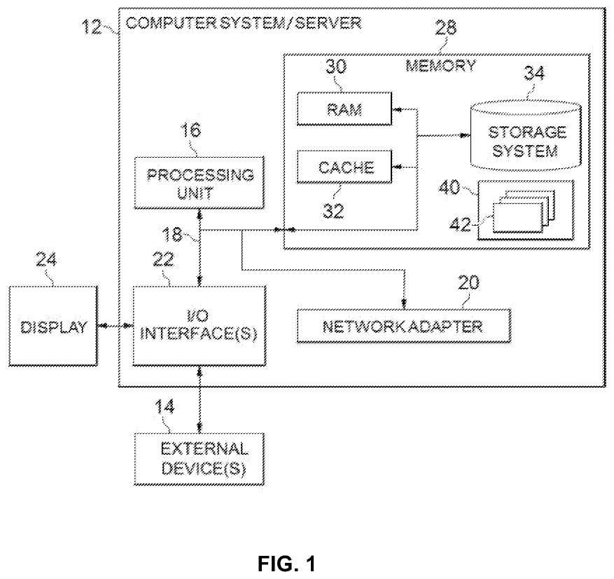

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

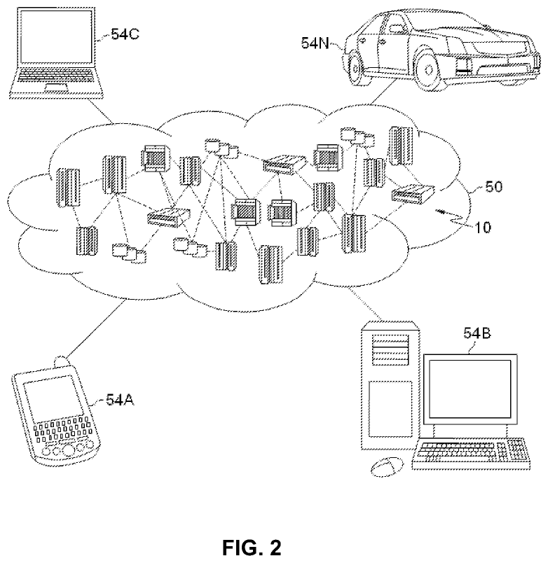

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

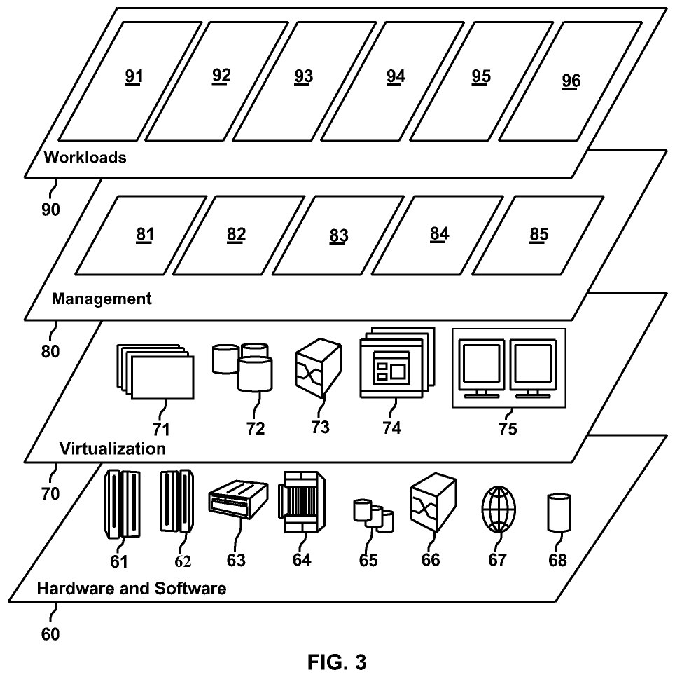

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and failure-based storage rebuilding 96.

With the development of the storage technology, capacity of storage device is increasing. The larger the capacity of a storage device, the more time is required for rebuilding the data for the storage device in case it fails. For example, when a storage device having 15 T capacity fails, it will take several hours to rebuild the data.

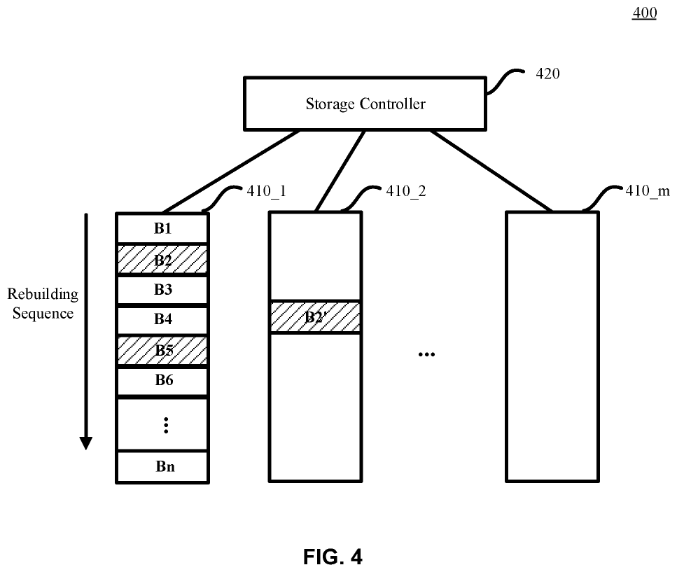

FIG. 4 depicts an exemplary schematic diagram of a storage system 400. The storage system 400 includes a plurality of storage devices 410_1, 410_2, . . . , 410_m and a storage controller 420. The storage controller 420 represents one or more storage controllers configured to control the storage devices 410_1, 410_2, . . . , and 410_m. Each of the storage devices includes a plurality of memory blocks B1, . . . , and Bn. FIG. 4 only illustrates the memory blocks (from the first memory block B1 to the last memory block Bn) in the first storage device 410_1. It is to be noted that, for the sake of brevity, other components of the storage system 400 irrelevant to the present invention are not depicted. The storage controller 420 may be implemented by a Host Bus Adapter (HBA) or a Field Programmable Gate Array (FPGA). Generally, the storage controller may include one or more processors and a memory coupled to the one or more processors.

In the storage system 400, the second memory block B2 and the fifth memory block B5 of the first storage device 410_1 fail, which are shaded as shown in FIG. 4. In this case, a spare storage device (not shown) may be used to replace the first storage device 410_1. The data associated with the first storage device 410_1 may be rebuilt on the spare storage device. As shown in FIG. 4, all the memory blocks B1, . . . , and Bn of the first storage device 410_1 will be rebuilt in a predetermined sequence, e.g., from the first memory block B1 to the last memory block Bn. In the example of FIG. 4, one memory block B2′ of the second storage device 410_2 may have redundant data of the second memory block B2 of the first storage device 410_1. The storage controller 420 may use the redundant data on memory block B2′ to rebuild the second memory block B2 of the first storage device 410_1. There is a risk of data loss when the second storage device 410_2 fails, during the rebuilding process. Because if the memory block B2′ fails, the storage controller 420 cannot rebuild the second memory block B2 of the first storage device 410_1.

The present disclosure provides embodiments for implementing failure-based storage rebuilding to reduce the rebuilding time so as to avoid risking data loss.

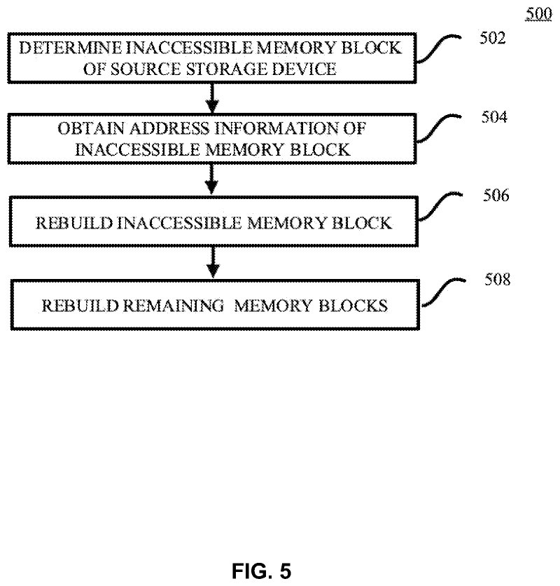

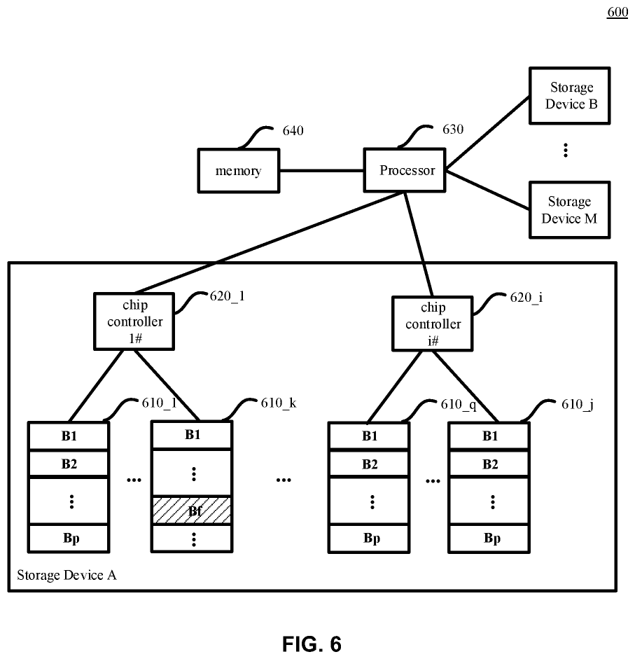

With reference now to FIG. 5, it shows schematic flowchart of a method 500 for failure-based storage rebuilding implemented in a storage system, in accordance with one embodiment of the present invention. FIG. 6 shows an exemplary schematic diagram of a storage system 600, in accordance with one embodiment of the present invention. The storage system 600 may include a plurality of storage devices A, B, . . . , and M, a processor 630 coupled to the storage devices A, B, . . . , and M, and a memory 640 coupled to the processor 630. The processor 630 may represent one or more processors in the following description. The processor 630 and the memory 640 may be embodied in or communicatively coupled to a storage controller, such as the storage controller 420 as shown in FIG. 4. The storage devices A, B, . . . , and M, may be a flash storage device, such as a flash module or a flash card. Each storage device may include a plurality of memory chips 610_1, . . . , and 610_j, and a plurality of chip controllers 620_1, . . . , and 620_i. An individual chip controller of the chip controllers 620_1, . . . , and 620_i controls the access to one or more of the memory chips 610_1, . . . , and 610_j. In the embodiment of FIG. 6, the first chip controller 620_1 may control the access to the memory chips 610_1, . . . , and 610_k. The i-th chip controller 620_i may control the access to the memory chips 610_q, . . . , and 610_j. Each of the memory chips 610_1, . . . , and 610_j includes a plurality of memory blocks B1, . . . , and Bp.

As shown in FIG. 5, at step 502, the processor 630 determines an inaccessible memory block Bf of a source storage device A. The inaccessible memory block Bf may be a memory block Bf of one (for example, the k-th memory chip 610_k) of the memory chips 610_1, . . . , and 610_j, which cannot be accessed. As to each memory chip 610_1, . . . , and 610_j, respective memory blocks have respective internal logical block addresses. The internal logical block address includes a range of internal logical memory addresses. For example, the internal logical block address of the first memory block B1 of the first memory chip 610_1 may include the internal logical memory addresses from 000 to 015. The internal logical block address of the second memory block B2 of the first memory chip 610_1 may include the internal logical memory addresses from 016 to 030. As to the storage device, the respective memory blocks have respective external logical block addresses. The external logical block address includes a range of external logical memory addresses. For example, the external logical block address of the first memory block B1 of the first memory chip 610_1 may include the external logical memory addresses from 0x00 to 0x0F. The external logical block address of the second memory block B2 of the first memory chip 610_1 may include the external logical memory addresses from 0x70 to 0x7F.

There is a mapping among the memory chips 610_1, . . . , and 610_j, the chip controllers 620_1, . . . , and 620_i, the internal logical block addresses of respective memory chips 610_1, . . . , and 610_j and the external logical block addresses of the storage device A, B, . . . , and M. This mapping may be stored in the storage devices A, B, . . . , and M. An example of this mapping is shown in Table 1.

TABLE 1

| External Logical | Internal Logical | Memory | Chip |
|---|---|---|---|
| Block Address | Block Address | chip | controller |
| 0x00-0x0F | 000-015 | #1 | #1 |
| 0x10-0x1F | 000-015 | #2 | #1 |
| 0x20-0x2F | 000-015 | #3 | #1 |
| 0x30-0x3F | 000-015 | #4 | #1 |
| 0x40-0x4F | 100-115 | #1 | #2 |
| 0x50-0x5F | 100-115 | #2 | #2 |
| . . . | . . . | . . . | . . . |

For example, as shown in the second row of Table 1, the internal logical block address 000-015 of memory chip #1 (which is under the control of chip controller #1), corresponds to the external logical block address 0x00-0x0F. As shown in the seventh row, the internal logical block address 100-115 of memory chip #2 (which is under the control of chip controller #2), corresponds to the external logical block address 0x50-0x5F.

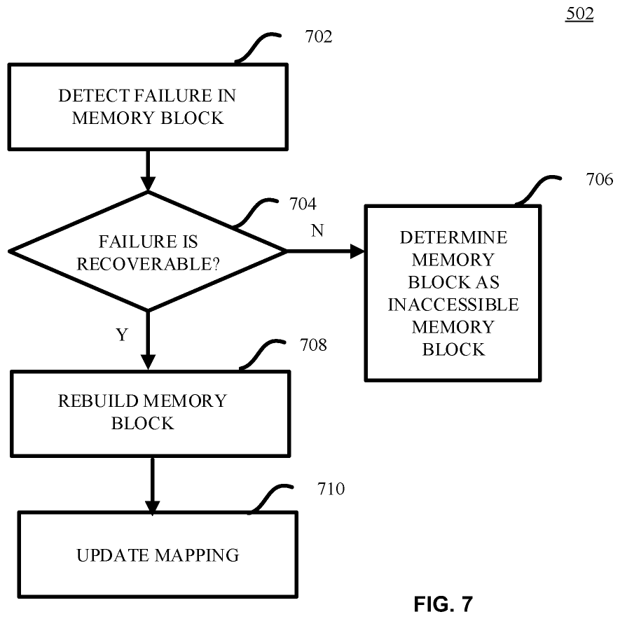

FIG. 7 illustrates a schematic flowchart of a process of determining the inaccessible memory block Bf of the source storage device A, in accordance with one embodiment of the present invention.

As shown in FIG. 7, at step 702, a failure in the memory block Bf of the source storage device A is detected. According to an embodiment of the invention, the failure may be detected by the chip controller 620_1, for example. As shall be appreciated by those skilled in the art, in one embodiment, the memory chip 610_k may report a failure of its memory location to the corresponding chip controller 620_1. Then, the chip controller 620_1 may determine that the memory block Bf containing that memory location has a failure. In another embodiment, the memory chip 610_k may report a failure of its memory block Bf to the corresponding chip controller 620_1, if a memory location of that memory block Bf has a failure. In still another embodiment, the chip controller 620_1 may check its corresponding memory chips 610_1, . . . , and 610_k to detect a failure.

At step 704, the chip controller 620_1 that has detected the failure determines whether the failure is recoverable. According to an embodiment of the present disclosure, the storage device may reserve a certain amount of extra storage space besides the storage space currently available to be used. The extra storage space may be used to recover from failures including, e.g., block wear-out, disturb errors, plane failures, and even the failure of an entire chip. If the extent of failure reaches a threshold, any further failures may not be recoverable with the extra storage space. In this way, whether a failure is recoverable or not may be determined.

If the failure is unrecoverable (“N” branch of step 704), at step 706, the processors 630 determines the memory block Bf as the inaccessible memory block. If the failure is recoverable (“Y” branch of step 704), at step 708, the chip controller 620_1 that has detected the failure rebuilds the memory block Bf by using the extra storage space. After rebuilding the memory block Bf, the mapping among the memory chips 610_1, . . . , and 610_j, the chip controllers 620_1, . . . , and 620_i, the internal logical block addresses of the corresponding memory chip and the external logical block addresses of the source storage device is changed. Then, at step 710, the processor 630 updates the mapping based on correspondence after rebuilding.

Back to FIG. 5, at step 504, the processor 630 obtains address information of the inaccessible memory block of the source storage device A. In one embodiment, the processor 630 may establish a table in the memory 640 to record address information of the inaccessible memory block Bf. The address information of the inaccessible memory block at least includes an external logical block address of the source storage device A corresponding to the inaccessible memory block Bf. In some embodiments, the address information of the inaccessible memory block may further include an ID of the source storage device A. An example of the table recording address information of the inaccessible memory block is shown in Table 2.

TABLE 2

| External Logical | Storage |
|---|---|
| Block Address | Device ID |
| 0x00-0x0F | #1 |
| 0x40-0x4F | #1 |
| 0x80-0x8F | #1 |
| 0xB0-0xBF | #1 |
| . . . | . . . |

For example, as shown in Table 2, each row records address information of one inaccessible memory block. In Table 2, the inaccessible memory blocks includes the memory blocks of storage device #1 (i.e., storage device A) having the external logical block address 0x00-0x0F, 0x40-0x4F, 0x80-0x8F, 0xB0-0xBF, and so on.

At step 506, the processor 630 rebuilds the inaccessible memory block of the source storage device A. The processor 630 may rebuild the data associated with the inaccessible memory block on a spare storage device (hereinafter referred to as “target storage device”). In the embodiments, any existing or future storage rebuilding technique can be used to rebuild the inaccessible memory block. During this period, there is a risk of data loss if another storage device having the redundant data in the storage system 600 fails.

After rebuilding the inaccessible memory block, at step 508, the processor 630 rebuilds remaining memory blocks of the source storage device A. The remaining memory blocks are all accessible memory blocks. During this period, there is no risk of data loss because the remaining memory blocks still have redundancy in the storage system 600.

The time to rebuild the inaccessible memory block may be much shorter than the time to rebuild all the memory blocks of the source storage device A. Therefore, the period having a risk of data loss in the embodiments of the present disclosure is largely reduced. In this way, the storage system 600 according to the embodiments of the present disclosure may possess higher availability.

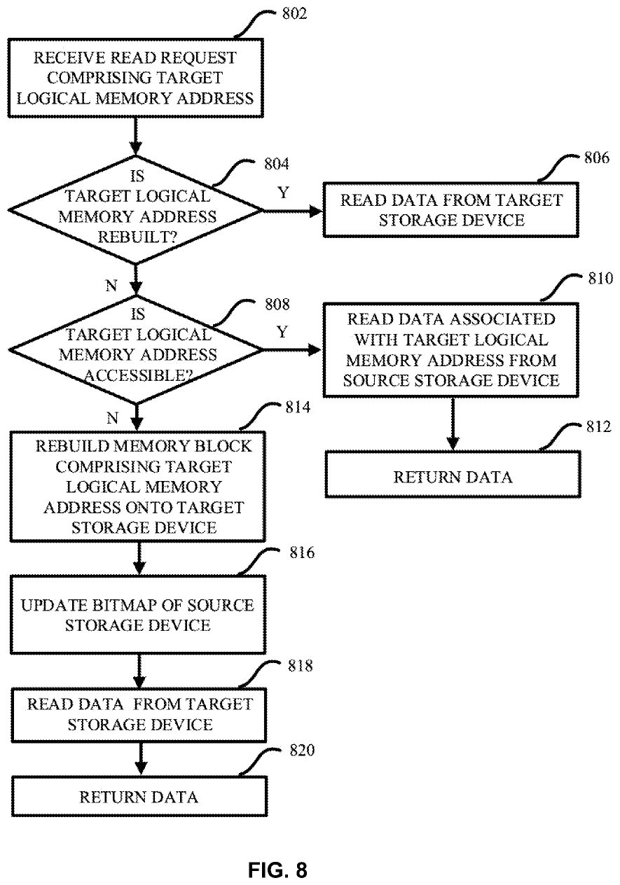

During the rebuilding process, the storage system 600 may be accessed by a host. The host may be for example a server. FIG. 8 shows a schematic flowchart of further steps of the method 500 when the storage system 600 receives a read request from the host, in accordance with one embodiment of the present invention.

As shown in FIG. 8, at step 802, the processor 630 receives a read request from the host. The read request includes a target logical memory address of the source storage device.

At step 804, the processor 630 determines whether the target logical memory address has been rebuilt. The memory of the storage controller may include a bitmap which includes the rebuilding statuses of respective logical memory addresses of the source storage device. The processor 630 may retrieve the bitmap to determine whether the target logical memory address has been rebuilt.

If the target logical memory address has been rebuilt (“Y” branch of step 804), at step 806, the processor 630 reads data associated with the target logical memory address from the target storage device. Then, the processor 630 returns the data to the host.

If the target logical memory address has not been rebuilt (“N” branch of step 804), at step 808, the processor 630 determines whether the target logical memory address is accessible.

If the target logical memory address is accessible (“Y” branch of step 808), at step 810, the processor 630 reads data associated with the target logical memory address from the source storage device. Then, at step 812, the processor 630 returns the data to the host.

If the target logical memory address is inaccessible, (“N” branch of step 808), at step 814, the processor 630 rebuilds a memory block including the target logical memory address on the target storage device.

Then, at step 816, the processor 630 updates the bitmap of the source storage device to indicate that that memory block has been rebuilt. In this case, the processor 630 does not need to rebuild that memory block again. In some embodiments, the action taken at step 816 may be executed prior to or at the same time as the action taken at step 814.

At step 818, the processor 630 reads data associated with the target logical memory address from the target storage device. Then, at step 820, the processor 630 returns the data to the host.

According to the embodiment as shown in FIG. 8, the failed source storage device is still readable even if it has not been rebuilt completely.

In some alternative embodiments, the storage controller may not take the actions at steps 814-820. If the target logical memory address is inaccessible, (“N” branch of step 808), the processor 630 may return a response to the host to indicate that data associated with the target logical memory address is inaccessible. In this case, the accessible memory blocks of the source storage device is still readable.

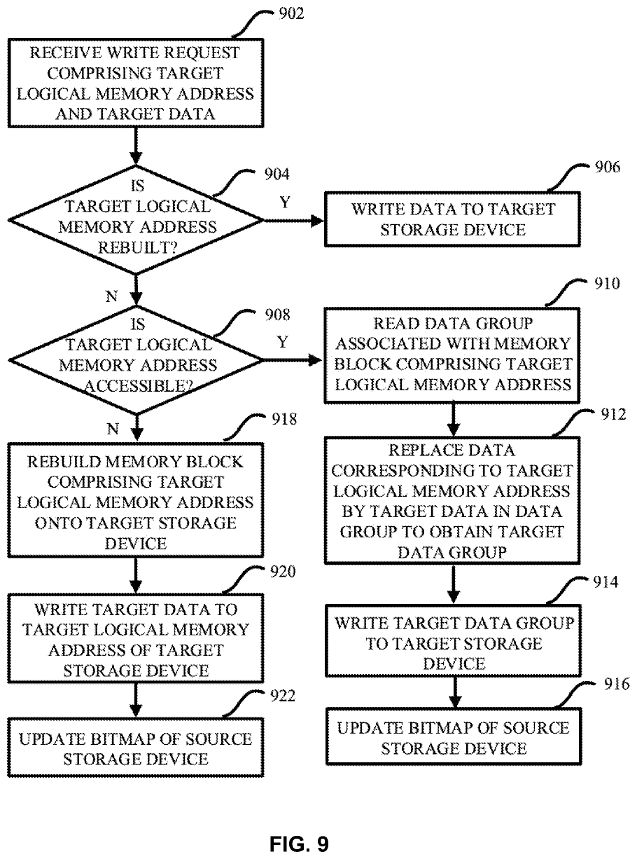

FIG. 9 shows a schematic flowchart of further steps of the method 500 when the storage system 600 receives a write request from the host, in accordance with another embodiment of the present invention.

As shown in FIG. 9, at step 902, the processor 630 receives a write request from the host. The write request includes a target logical memory address of the source storage device and target data to be written to the target logical memory address.

At step 904, the processor 630 determines whether the target logical memory address has been rebuilt. The memory of the storage controller may include a bitmap which includes the rebuilding statuses of the respective logical memory addresses of the source storage device. The processor 630 may retrieve the bitmap to determine whether the target logical memory address has been rebuilt.

If the target logical memory address has been rebuilt (“Y” branch of step 904), at step 906, the processor 630 writes the target data to the target storage device.

If the target logical memory address has not been rebuilt (“N” branch of step 904), at step 908, the processor 630 determines whether the target logical memory address is accessible.

If the target logical memory address is accessible (“Y” branch of step 908), at step 910, the processor 630 reads a data group associated with the memory block including the target logical memory address. The data group may be stored in a cache of the storage controller temporally.

At step 912, the processor 630 replaces the data corresponding to the target logical memory address in the data group with the target data, to obtain a new data group (hereinafter referred to as “target data group”).

At step 914, the processor 630 writes the target data group to the target storage device. Then, at step 916, the processor 630 updates the bitmap of the source storage device to indicate that the memory block including the target logical memory address has been rebuilt. In some embodiments, the action taken at step 916 may be executed prior to or at the same time as the action taken at step 914.

If the target logical memory address is inaccessible, (“N” branch of step 908), at step 918, the processor 630 rebuilds the memory block including the target logical memory address on the target storage device.

At step 920, the processor 630 writes the target data to the target logical memory address of the target storage device. Then, at step 922, the processor 630 updates the bitmap of the source storage device to indicate that the memory block including the target logical memory address has been rebuilt. In some embodiments, the action taken at step 922 may be executed prior to or at the same time as the action taken at step 920.

Under the same inventive concept, another embodiment of the present disclosure can provide a storage system. The storage system may include a plurality of storage devices, one or more processors, a memory coupled to at least one of the processors, and a set of computer program instructions stored in the memory. The set of computer program instructions are executed by at least one of the processors to determine an inaccessible memory block of a source storage device; obtain address information of the inaccessible memory block of the source storage device; rebuild the inaccessible memory block of the source storage device based on the address information; and rebuild remaining memory blocks of the source storage device.

Similarly, under the same inventive concept, another embodiment of the present disclosure can provide a computer program product implemented in a storage system. The computer program product comprises a computer readable storage medium having program instructions embodied therewith. The program instructions are executable by one or more processors to implement the method according to the embodiments of the present disclosure.

The terminology used herein is for the purpose of describing particular aspects of the disclosure only, and is not intended to limit the invention. As used herein and in the appended claims, the singular form of a word includes the plural, and vice versa, unless the context clearly dictates otherwise. Thus, singular words are generally inclusive of the plurals of the respective terms. It should be noted that the word “comprising” or “include” does not necessarily exclude the presence of other elements or steps than those listed.

It should be noted that the processing of failure-based storage rebuilding according to embodiments of this disclosure could be implemented by computer system/server 12 of FIG. 1. It should also be noted that, in addition to the cloud system described above, embodiments of the present disclosure can be implemented in any computer and network systems.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the C programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for failure-based storage rebuilding, the method comprising:
determining, by one or more processors, an inaccessible memory block of a source storage device;
obtaining, by the one or more processors, address information of the inaccessible memory block of the source storage device;
rebuilding, by the one or more processors, the inaccessible memory block of the source storage device, based on the address information; and
rebuilding, by the one or more processors, remaining memory blocks of the source storage device.

2. The computer-implemented method of claim 1, wherein the source storage device comprises a plurality of memory chips and a plurality of chip controllers, wherein an individual chip controller of the chip controllers controls one or more of the memory chips, wherein the determining the inaccessible memory block of the source storage device comprises:
causing, by the one or more processors, the chip controllers to detect a failure in a memory block of the source storage device;
causing, by the one or more processors, a chip controller that has detected the failure to determine whether the failure is recoverable; and
determining, by the one or more processors, the memory block as the inaccessible memory block, in response to the failure being unrecoverable.

3. The computer-implemented method of claim 1, wherein the address information of the inaccessible memory block comprises an external logical block address of the source storage device.

4. The computer-implemented method of claim 1, further comprising:
receiving from a host, by the one or more processors, a read request comprising a target logical memory address of the source storage device;
determining, by the one or more processors, whether the target logical memory address has been rebuilt by retrieving a bitmap, wherein the bitmap comprises rebuilding statuses of respective logical memory addresses of the source storage device;
in response to the target logical memory address having not been rebuilt, determining, by the one or more processors, whether the target logical memory address is accessible;
in response to the target logical memory address being accessible, reading, by the one or more processors, data associated with the target logical memory address from the source storage device; and
returning, by the one or more processors, the data to the host.

5. The computer-implemented method of claim 4, further comprising:
in response to the target logical memory address being inaccessible, rebuilding, by the one or more processors, a memory block comprising the target logical memory address on a target storage device;
updating, by the one or more processors, the bitmap of the source storage device;
reading, by one or more processors, data associated with the target logical memory address from the target storage device; and
returning, by the one or more processors, the data to the host.

6. The computer-implemented method of claim 4, further comprising:
in response to the target logical memory address being inaccessible, returning, by the one or more processors, a response to the host to indicate that the target logical memory address is inaccessible.

7. The computer-implemented method of claim 1, further comprising:
receiving from a host, by the one or more processors, a write request comprising a target logical memory address of the source storage device and target data;
determining, by the one or more processors, whether the target logical memory address has been rebuilt by retrieving a bitmap, wherein the bitmap comprises rebuilding statuses of respective logical memory addresses of the source storage device;
in response to the target logical memory address having not been rebuilt, determining, by the one or more processors, whether the target logical memory address is accessible;
in response to the target logical memory address being accessible, reading, by the one or more processors, a data group associated with a memory block comprising the target logical memory address;
replacing, by the one or more processors, data corresponding to the target logical memory address by the target data in the data group, to obtain a target data group;
writing, by the one or more processors, the target data group to a target storage device; and
updating, by the one or more processors, the bitmap of the source storage device.

8. The computer-implemented method of claim 7, further comprising:
in response to the target logical memory address being inaccessible, rebuilding, by the one or more processors, the memory block comprising the target logical memory address on the target storage device;
writing, by the one or more processors, the target data to the target logical memory address of the target storage device; and
updating, by the one or more processors, the bitmap of the source storage device.

9. A computer program product for failure-based storage rebuilding, the computer program product comprising one or more computer-readable tangible storage devices and program instructions stored on at least one of the one or more computer-readable tangible storage devices, the program instructions executable to:
determine, by one or more processors, an inaccessible memory block of a source storage device;
obtain, by the one or more processors, address information of the inaccessible memory block of the source storage device;
rebuild, by the one or more processors, the inaccessible memory block of the source storage device, based on the address information; and
rebuild, by the one or more processors, remaining memory blocks of the source storage device.

10. The computer program product of claim 9, wherein the source storage device comprises a plurality of memory chips and a plurality of chip controllers, wherein an individual chip controller of the chip controllers controls one or more of the memory chips, wherein the program instructions for determining the inaccessible memory block of the source storage device are further executable to:
cause, by the one or more processors, the chip controllers to detect a failure in a memory block of the source storage device;
cause, by the one or more processors, a chip controller that has detected the failure to determine whether the failure is recoverable; and
determine, by the one or more processors, the memory block as the inaccessible memory block, in response to the failure being unrecoverable.

11. The computer program product of claim 9, wherein the address information comprises an external logical block address of the source storage device corresponding to the inaccessible memory block.

12. The computer program product of claim 9, the program instructions further executable to:
receive from a host, by the one or more processors, a read request comprising a target logical memory address of the source storage device;
determine, by the one or more processors, whether the target logical memory address has been rebuilt by retrieving a bitmap, wherein the bitmap comprises rebuilding statuses of respective logical memory addresses of the source storage device;
in response to the target logical memory address having not been rebuilt, determine, by the one or more processors, whether the target logical memory address is accessible;
in response to the target logical memory address being accessible, read, by the one or more processors, data associated with the target logical memory address from the source storage device; and
return, by the one or more processors, the data to the host.

13. The computer program product of claim 12, the program instructions further executable to:
in response to the target logical memory address being inaccessible, rebuild, by the one or more processors, a memory block comprising the target logical memory address on a target storage device;
update, by the one or more processors, the bitmap of the source storage device;
read, by one or more processors, data associated with the target logical memory address from the target storage device; and
return, by the one or more processors, the data to the host.

14. The computer program product of claim 12, the program instructions further executable to:
in response to the target logical memory address being inaccessible, return, by the one or more processors, a response to the host to indicate that the target logical memory address is inaccessible.

15. The computer program product of claim 9, the program instructions further executable to:
receive from a host, by the one or more processors, a write request comprising a target logical memory address of the source storage device and target data;
determine, by the one or more processors, whether the target logical memory address has been rebuilt by retrieving a bitmap, wherein the bitmap comprises rebuilding statuses of respective logical memory addresses of the source storage device;
in response to the target logical memory address having not been rebuilt, determine, by the one or more processors, whether the target logical memory address is accessible;
in response to the target logical memory address being accessible, read, by the one or more processors, a data group associated with a memory block comprising the target logical memory address;
replace, by the one or more processors, data corresponding to the target logical memory address by the target data in the data group, to obtain a target data group;
write, by the one or more processors, the target data group to a target storage device; and
update, by the one or more processors, the bitmap of the source storage device.

16. The computer program product of claim 15, the program instructions further executable to:
in response to the target logical memory address being inaccessible, rebuild, by the one or more processors, the memory block comprising the target logical memory address on the target storage device;
write, by the one or more processors, the target data to the target logical memory address of the target storage device; and
update, by the one or more processors, the bitmap of the source storage device.

17. A computer system for failure-based storage rebuilding, the computer system comprising:
one or more processors, one or more computer readable tangible storage devices, and program instructions stored on at least one of the one or more computer readable tangible storage devices for execution by at least one of the one or more processors, the program instructions executable to:
determine, by one or more processors, an inaccessible memory block of a source storage device;
obtain, by the one or more processors, address information of the inaccessible memory block of the source storage device;
rebuild, by the one or more processors, the inaccessible memory block of the source storage device, based on the address information; and
rebuild, by the one or more processors, remaining memory blocks of the source storage device.

18. The computer system of claim 17, wherein the source storage device comprises a plurality of memory chips and a plurality of chip controllers, wherein an individual chip controller of the chip controllers controls one or more of the memory chips, wherein the program instructions for determining the inaccessible memory block of the source storage device are further executable to:
cause, by the one or more processors, the chip controllers to detect a failure in a memory block of the source storage device;
cause, by the one or more processors, a chip controller that has detected the failure to determine whether the failure is recoverable; and
determine, by the one or more processors, the memory block as the inaccessible memory block, in response to the failure being unrecoverable.

19. The computer system of claim 17, wherein the address information comprises an external logical block address of the source storage device corresponding to the inaccessible memory block.

20. The computer system of claim 17, the program instructions further executable to:
receive from a host, by the one or more processors, a read request comprising a target logical memory address of the source storage device;
determine, by the one or more processors, whether the target logical memory address has been rebuilt by retrieving a bitmap, wherein the bitmap comprises rebuilding statuses of respective logical memory addresses of the source storage device;
in response to the target logical memory address having not been rebuilt, determine, by the one or more processors, whether the target logical memory address is accessible;
in response to the target logical memory address being accessible, read, by the one or more processors, data associated with the target logical memory address from the source storage device; and
return, by the one or more processors, the data to the host.
